(19) United States
(12) Patent Application Publication
(10) Pub. No.: US 2015/0245644 A1
(43) Pub. Date: Sep. 3, 2015

(54) COMPOSITION OF NUTRIENTS AND BIOACTIVE SUBSTANCES WHICH PROMOTE GROWTH AND REDUCE INTOLERANCE AND SIDE EFFECTS IN PREMATURE INFANTS

(71) Applicant: NUCITEC, S.A. DE C.V., Querétaro, Queréta (MX)

(72) Inventors: Jorge Luis Rosado Loria, Queretaro (MX); Miguel Angel Duarte Vázquez, Queretaro (MX)

(73) Assignee: NUCITEC, S.A. DE C.V., Querétaro, Querétaro (MX)

(21) Appl. No.: 14/427,376

(22) PCT Filed: May 2, 2013
(86) PCT No.: PCT/MX2013/000058

§ 371 Date: Mar. 11, 2015

(30) Foreign Application Priority Data
Sep. 11, 2012 (MX) MX/A/2012/010487

(51) Int. Cl. A23L 1/29; A23L 1/303; A23L 1/304; A23L 1/302

(52) U.S. Cl. CPC A23L 1/296; A23L 1/302; A23L 1/303; A23L 1/304; A23V 2002/00

(57) ABSTRACT

The present disclosure is related to the obtaining of a nutritional formula for the feeding of preterm born infants. The formula comprises a mixture of casein; whey milk protein; alphalactalbumin; beta casein A2 protein, lactose; palmitic acid in beta position; non digestible oligosaccharides; long chain polyunsaturated fatty acids (LC PUFAS); nucleotides; vitamins and minerals; inositol, choline, taurine and carnitine in concentrations sufficient enough to satisfy nutritional requirements of premature children, besides being better-tolerated.

### FIELD OF THE DISCLOSURE

The present disclosure belongs to the field of nutrition and infant formulas. More specifically, the disclosure is related with the obtaining of a composition to be used as a feeding formula for preterm infants.

### BACKGROUND OF THE DISCLOSURE

Preterm infants or children born to preterm are those children who born before the 37^{th} week of gestation. Preterm children born at the beginning of the third trimester of the pregnancy frequently present a growth restriction due to the decrease in the intrauterine nutrients supply. The medical conditions of preterm children such as hypotension, hypoxia, bronchopulmonary dysplasia, infection and surgery, increase their metabolic energy requirements and thus their nutrients necessity. Besides, physiologic immaturity of the gastrointestinal tract obstructs the growth.

Preterm child is characterized by a very low storage of nutrients and at the same he has high energy, water and other nutrients requirements in order to recover the delay in his development; occasionally, serious disturbances due to immaturity and sometimes severe diseases are presented and usually related to digestion, absorption and nutrients metabolism and excretion.

In 1977 the American Academy of Pediatrics (AAP) stated that the optimal diet for a low weight preterm child would be one capable to make him grow as much as the fetus grow in the third month of gestation, without inducing metabolic or excessive excretory stress.

Most of the preterm infants have a good tolerance for breastmilk, nevertheless, breast milk lacks of the convenient quantities of some nutrients that preterm child requires.

In 1987 the ESPGHAN (European Society for Paediatric Gastroenterology, Hepatology and Nutrition) published the recommendations about the nutritional requirements of low weight born children; these recommendations include the newborn premature children that present less than 2500 grams of weight.

For preterm children with enteral nutrition, the energy requirements are between the 110 and 135 kcal/kg/day, without exceeding 150 kcal/kg/day that newborn with bronchopulmonar dyaplasia might need (ESPGHAN COMMITTEE ON NUTRITION; J Pediatr Gastroenterol Nutr 2010; 50:85-91).

The quantity and quality of the protein intake influences the metabolism and the growth rhythm of newborn children; even though there is controversy about the upper limit for proteins intake, nowadays there is enough evidence to consider as beneficial a protein/energy contribution from 3.2 to 3.6 g/100 kcal for the preterm children feeding of 1 to 1.8 kg but for preterm children <1 kg an intake from 3.6 to 4.1 g/100 kcal is recommended (ESPGHAN COMMITTEE ON NUTRITION; J Pediatr Gastroenterol Nutr 2010; 50:85-91). The rate of whey proteins/casein must be at least 60/40.

Preterm children have a poor relative capability to absorb fat by the enteral via, mostly saturated fat. This limitation is associated with the hepatic immaturity and the decrease in the synthesis of bile acids during the first weeks of life. Fat recommendations for the preterm infants are between 4.6-6 g/kg/day or at least 40-55% of the caloric contribution. It has been showed that medium chain triglycerides (MCTs 6-12 carbons) as part of the fat content of artificial milk improves fat absorption but carnitine is required in order to be able to metabolize the MCTs (Rebuche et al., 1990; Am J Clin Nutr, 52:820-824). It is recommended the addition of DHA and ARA in the adequate quantity and ratio since otherwise the children growth could be affected (Clandinin et al., J Pediatr; 2005, 146:461-468).

Related to the carbohydrates requirements, these are not full defined but there it is mentioned that these must provide between 40-50% of energy. Although the intestinal lactase does not reach normal values till the term of gestation, the idea that sucrose must not be used and that lactose must be still the main carbohydrate predominates. The carbohydrates content may be complemented with glucose polymers that help to maintain a low osmolarity (Wirth et al., J Pediatr 1990; 117:283-287). Monosaccharides are used by the preterm infants as energetic source and for the synthesis of complex molecules, while oligosaccharides have a stimulant effect on the growth of intestinal bifidobacteria and cause a higher frequency of softer stool consistency, which may help to improve the intestinal tolerance to feeding.

On the other hand, nucleotides may influence in a positive way the maturity of the gastrointestinal tract and the immune response in preterm infant.

An important number of feeding formulas for preterm babies have been developed; this kind of formulas must promote a growth that results similar to the intrauterine one taking into account the high immaturity degree that some physiological functions have, thus these formulas must bring together some characteristics that are different from the ones of the formulas for newborn children that accomplished the normal period of gestation.

Nestle commercializes the formula PreNan®, which is an special formula intended for low weight birth infants including preterm newborns and insufficient weight full term birth children. Such formula does not contain prebiotic oligosaccharides, which are the third component in human milk.

Another highly commercialized and prescribed for preterm infants or for low weight birth children is Blemil Plus® Prematuros from Laboratorios Ordesa (Barcelona, Espana). The formula is prescribed for infants with low weight birth, even if they are premature or not. With reference to the protein contribution, this formula contributes with 2.3 g/100 ml, slightly under the recommendations of this nutrient, however it does not contain prebiotic oligosaccharides. Another formula that shares these characteristics is SMA Prematuros®.

The previously described formulas present common limitations such as:
a) The non-alphalactalbumin supplementation, a whey protein with excellent nutritional quality that forms between 20-30% of the total protein in human milk, that gives it a higher tolerability and less allergenicity to the breast milk. Besides being a good source of essential amino acids, alphalactalbumin has diverse positive physiological effects such as antimicrobial activity, increase of the immune function, acts as a prebiotic and increases minerals absorption.
b) There is not considered the substitution of beta casein A1 for beta casein A2, which would set the infant at a bigger risk of suffering metabolic alterations due to the release of the peptide beta casomorphin (BCM 7) which is obtained by the hydrolysis of the beta casein A1.
c) Regarding to the carbohydrates fraction, the described formulas do not contain prebiotic oligosaccharides, which are the third component of the human milk. The oligosaccharides that are not digested in the gastrointestinal tract of the newborn constitute the “soluble fiber” of the breast milk, providing in this way the bacteria of the colon of the infant with substrate. The intake of enough quantity of soluble fiber stimulates the growing of beneficial bacteria in the colon of newborn infants.
d) The lipid fraction of these formulas is constituted by a combination of coconut oil, soybean oil, palm olein, intermediate chain triglycerides, polyunsaturated long chain fatty acids, soy lecithin; nevertheless, it does not consider the addition of palmitic acid in beta position. In preterm infants fed with formula it has been observed that palmitic acid salts in alpha position are the main precursor of constipation events occurrence.
e) Lack of nucleotides. The nucleotides in the diet form part of the nitrogen non protein fraction of breast milk and are imperative for the tissue formation in fast development such as the intestinal epithelium or the lymphoid cells.

On the other hand, solicitude US 2010/0234286 A1 describes a composition and a method for the infants feeding with low, very low and extremely low weight newborns arguing that this formula has a better tolerance, however, this disclosure does not consider the addition of a palmitic acid source bound to the beta carbon of the fatty acid (beta-palmitate), this substance increases the palmitic acid concentration to achieve the recommended quantity of 25% of the total fatty acids. It does not consider supplementation of alphalactalbumin or the substitution of casein A1 for casein A2. Neither the addition of nucleotides is considered in this formula, and due to the immaturity of the different tissues and the role that the nucleotides have in the development and maturation on these, this would be a clear disadvantage.

The solicitude US 2004/0143013 A1, describes a method for increasing the growth of preterm infants which involves the administration of a formula that contains a combination of long chain polyunsaturated fatty acids, mainly docosahexaenoic acid (DHA) and arachidonic acid (ARA). Even though the content of these essential fatty acids is adequate for premature newborns, the document does not specify nor qualitative or quantitatively the presence of other components that, as previously described, would be very beneficial for these children such as the kind of protein, prebiotics and nucleotides, among others.

In the U.S. Pat. No. 6,162,472 a milk-based formula for preterm infants feeding is described. This formula has a lactose-reduced content (less than 20%) in order to improve tolerability. In this formula, the protein source has a ratio of 40:60 casein:whey proteins but there is not described the addition of another compounds such as alpha lactalbumin or the substitution of the fraction of beta casein A1 for beta casein A2. The use of prebiotic oligosaccharides is not mentioned; neither the adding of nucleotides is mentioned, which are important for the development of some tissues or the adding of a palmitic acid source in beta position, so the risk of calcium soaps formation is relatively high.

In the publication US 2005/0058690 A1, the use of an infant formula that contains nucleotides is described, for its use in preterm infants, to promote their growth. The composition lacks of some components; for example, it does not mention the adding of alpha lactalbumin or the substitution of beta casein A1 for beta casein A2. The composition of this disclosure neither considers the addition of prebiotic oligosaccharides or the addition of a source of palmitic acid in beta position.

In the publication US 2004/0214791 A1, diverse formulas that contain proteins, lipids and carbohydrates are described, for its use in the feeding of preterm infants. The described compositions have a high content of lactose which may form even a 67% of the total carbohydrates. The authors argue that even though premature babies present lactose intolerance, this intolerance disappears when babies are discharged from the hospital. Nevertheless, the formula loses relevance since preterm preparations are used during the hospitalization process when the premature child is in recovery process, once he or she has left the hospital he has reached the maturity of his or her systems and is able to consume another preparations. Furthermore, it is not mentioned that a combination of whey proteins is used: enough casein to reach an adequate amino acids profile, neither alphalactalbumin addition is considered or the substitution of beta casein A1 for beta casein A2. About other nutrients, it does not consider the addition of prebiotics or nucleotides, so in general this is a formula with a lot of deficiencies.

### DESCRIPTION OF THE DISCLOSURE

The object composition of the present disclosure supplies the protein quantity which contributes with 5-20 kcal, being preferred between 10.4 and 14.4 kcal; still preferably 12.4 k cal; carbohydrates which supply between 20 and 50 kcal, being preferred 38 kcal; and fat that contributes between 39.6 and 55 kcal, preferably 49 kcal for every 100 total kcal of the formula.

The composition of the present disclosure includes whey protein:casein ratio between 80:20 and 20:80; preferably of 65:35; alphalactalbumin in quantities, rated to the total protein, between 20 and 30%, being preferred 26%; a beta casein protein content with a ratio of type A1 and type A2 between 3:97 and 70:30; preferably in a ratio of 40:60, where the main protein source comes from milk from Jersey or Guernesey cattle with the objective of increasing the content of A2 casein. The carbohydrates source consists in a lactose, maltodextrin and starch mixture; the lactose content is between 10 and 70% of total carbohydrates, being preferred 50%; the palmitic acid content is between the 10 and 50% of total fatty acids, preferably 25% where from the total palmitic acid, between 25 and 70% of it is esterified in position 2 of glycerol (beta palmitate), preferably 45%. Moreover, the formula is enriched with: a) docosahexaenoic acid (DHA) and arachidonic acid (ARA), where the DHA is between 1 and 5% quantity of the total fatty acids, while the arachidonic acid (ARA) is in ratio from 1-10% of total fatty acids, more adequately both fatty acids are rated ARA:DHA 1:2 to 5:1, being preferred 1:1 to 3:1, still more adequately 2:1; b) oligosaccharides; where prebiotic oligosaccharides are fructooligosaccharides and galactooligosaccharides; and fructooligosaccharides are in concentration between 0.05 and 0.2 grams per every 100 g of formula; preferably 0.533 g/100 g of formula; the galactooligosaccharides are in concentration between 0.1 and 10 g per every 100 g of formula; being preferred 4.79 g per ever 100 g of formula; c) a nucleotides mixture in a ratio between 1 and 15 mg per every 100 kcal, preferably 3.8 mg/100 kcal; the nucleotides mixture is constituted as follows:
Adenosine monophosphate (AMP) between 0.1 and 3.5 mg/100 kcal, preferably 0.56 mg/100 kcal.
Cytidine monophosphate (CMP) between 0.5 and 5 mg/100 kcal, preferably 1.9 mg/100 kcal.
Guanosine monophosphate (GMP) between 0.1 and 5 mg every 100 kcal, preferably 0.39 mg per every 100 kcal.
Inosine monophosphate between 0.01 mg and 5 mg per every 100 kcal, preferably 0.23 mg per every 100 kcal.
Uridine monophosphate between 0.1 mg and 7 mg per every 100 kcal, preferably 0.76 mg per every 100 kcal.

Besides, the formula includes selected vitamins and minerals among others sodium, potassium, calcium, phosphorus, chlorine, magnesium, manganese, iron, copper, zinc, selenium, iodine, vitamin A, C, D, E, K, all vitamins from B complex (B1, B2, B6 and B12), niacin, pantothenic acid and mixtures of them. Equally, it includes inositol in concentration between 2 and 54 mg per every 100 kcal, preferably 44 mg per very 100 kcal; choline in concentration between 5 and 30 mg per every 100 kcal, being preferred 16 mg per every 100 kcal; taurine between 5 and 12 mg per every 100 kcal, preferably 6.9 mg per every 100 kcal; and carnitine in concentration between 1 and 15 mg per every 100 kcal; preferably 3.0 mg per every 100 kcal.

The protein content of the object composition of the present disclosure is 3.1 g/100 kcal, which supplies the adequate amount of protein to impulse the development in preterm infants. The formula not only supplies enough quantity of protein but also supplies the protein quality, since this fraction is formed by a ratio 65:35 whey protein:casein, which gives an adequate balance of essential amino acids, also, differently from other formulas in which the quantity of whey protein has being indiscriminately increased, this formula has been enriched with alphalactalbumin, which constitutes a 26% of the total protein, reducing in a direct way the concentration of beta lactoglobulin, which is the main whey protein but is highly allergenic. This composition reduces in significant way milk intolerance, allergies possibility and also reduces side effects such as colic, constipation and reflux which are presented with the existing formulas mainly due to the immaturity of the digestive system of premature infants.

In another modality of the disclosure, protein is supplied as extensive or partial hydrolysates of whey protein and casein, attempting to increase its digestibility.

The disclosure composition is also characterized for having a higher percentage of beta casein A2 than normal milk formulas. In normal milks, from the total of beta casein content no more than 30% is found as A2; while in our formula more than 60% of beta casein is found as beta casein A2. When structure A1 exists in a higher proportion in milk, the bioactive peptide beta casomorphin is releases; this peptide is implicated in the tendency to promote LDL oxidation increasing the risk of heart disease, affecting the insulin formation regulation, having higher allergenicity and negatively affecting the digestive process. Another alteration related to the bioactive peptide beta casomorphin increase is susceptibility to suffer autism due to the effect of this peptide on the opioid receptors.

The composition of our disclosure is enriched with prebiotic oligosaccharides, in same quantity and ratio as human milk. Oligosaccharides supply the substrate for the bacteria of the colon of the infant, contributing to the growing of beneficial bacteria in newborn infants. This has particular importance in preterm infants since intestine colonization by beneficial flora is late for 3-4 weeks, while pathogenic colonization occurs much earlier and at a higher level, and it is associated with an important health risk since it increases the risk of necrotizing enterocolitis. In the composition of the disclosure the prebiotic oligosaccharides are between 0.3 and 0.8 mg/100 ml of reconstituted formula, in a combination of 10% of fructooligosaccharides (FOS) and 90% of galactooligosaccharides (GOS).

The fats in the present disclosure contribute between 30 and 55% of the total energy. In the formula of the disclosure there is used a combination of fats including coconut oil, corn oil, olive oil, sunflower oil with a oleic acid high content, palm oil, canola oil, among others. With this fat combination medium chain fatty acids content between 40 and 50% of total fatty acids is reached, which stimulates the absorption of the fat without forcing an immature digestive apparatus.

The formula of the present disclosure contains docosahexaenoic acid (DHA) in a quantity which represents from 1 to 5% of the total fatty acids, while the arachidonic acid (ARA) is found in a ratio between 1-10% of the total fatty acids, more accurately, both fatty acids are found in a ratio ARA:DHA 1:2 to 5:1, being preferred 1:1 to 3:1, still preferably 2:1. These quantities have shown to be enough to obtain an adequate visual acuity which represents the beneficial effect on the development and maturation of the central nervous system.

In our formula no less than 45% of the palmitic acid is found as beta palmitate, which reduces the risk of suffering constipation.

The nucleotides composition of the present disclosure is as follows:

Adenosine monophosphate (AMP) 0.56 mg/100 kcal
Cytidine monophosphate (CMP) 1.9 mg/100 kcal
Guanosine monophosphate (GMP) 0.39 mg/100 kcal
Inosine monophosphate (IMP) 0.23 mg/100 kcal
Uridine monophosphate (UMP) 0.76 mg/100 kcal

The formula of the present disclosure also contains all the vitamins and minerals in the required quantities in order to guarantee an adequate development of the infant. The object composition of the present disclosure also contents vitamins, minerals and other nutrients that include but are not limited to, vitamin A, vitamin B1, vitamin B6, vitamin B12, vitamin E, vitamin K, vitamin C, vitamin D, folic acid, inositol, niacin, biotin, pantothenic acid, iron, magnesium, copper, zinc, manganese, chlorine, potassium, sodium, selenium, chrome, molybdenum, taurine, L-carnitine. Minerals are added on its more stable salt and bioavailable form. Nonetheless, compared to the formulas for full term birth children, the formula of the disclosure contains 1.5 times more calcium and phosphorus, as well as 2.5 times more vitamin A and vitamin D concentration.

### Example

An example of the formulation of the invention is presented in the following table only with illustrative purposes. As it will be appreciated by the experts on the technique, besides the ingredients specified next the infant formula may also contain other ingredients that are usually included in these particular products, including vitamins and minerals. The adequate final preparation is obtained by mixing 17 g of powder with enough water to reach a final volume of 100 mL. The energetic density obtained with this is 85 kcal/100 mL and a protein concentration of approximately 2.6 g of protein/100 mL. The protein sources used are isolate whey proteins concentrate, alphalactalbumin, lactoferrin and casein, which gives a ratio of casein:whey proteins from milk of 35:65, and a ratio of beta casein A2 of more than 60% of total beta caseins. The protein sources used contribute with approximately 26% of the total protein as alphalactalbumin and less than 7% as beta lactoglobulin.

The carbohydrates of the formula supply 37.8% of the total energy and at least 50% of the lactose is substituted by glucose polymers.

The fats of the formula supply 49% of the total energy. The sources of fat used in the disclosure composition are corn oil and soybean oil, among others.

In the composition there is used as a source of beta palmitate a mixture of triglycerides of vegetal and animal origin, which gives an esterified in beta position palmitic acid concentration of 45% of the total palmitic acid in the composition.

TABLE

| | | PER 100 |
|---|---|---|
| CONTENT | UNITS | KCAL |
| PROTEINS | G | 3.1 |
| whey:casein (65:35); 26% of the total | | |
| protein as alphalactoalbumin. Casein | | |
| 80% as Casein A2. | | |
| FAT (LIPIDS) | g | 5.5 |
| Linoleic acid | mg | 820 |
| Alpha-linolenic acid | mg | 110 |
| Docosahexaenoic acid (DHA) | mg | 17 |
| Arachidonic acid (ARA) | mg | 34 |
| CARBOHYDRATES | G | 9.5 |
| Lactose | G | 4.75 |
| Maltodextrin | G | 4.75 |
| Oligosaccharides | | |
| GOS | G | 0.11 |
| | MINERALS | |
| Calcium | Mg | 150 |
| Phophorus | Mg | 82 |
| Iron | Mg | 1.7 |
| Zinc | Mg | 1.1 |
| Copper | Mg | 0.120 |
| Sodium | Mg | 63 |
| Chlorine | Mg | 85 |
| Potassium | Mg | 100 |
| Magnesium | Mg | 10 |
| Selenium | μg | 2.4 |
| Iodine | μg | 31 |
| Manganese | Mg | 10 |
| Fluoride | μg | 20 |
| | VITAMINAS | |
| Vitamin A | μg RE | 337 |
| Vitamin D3 | μg | 3.8 |
| Vitamin E | Mg (alfa TE) | 4.5 |
| Vitamin K | μg | 9.2 |
| Vitamin C | Mg | 30 |
| Folic acid | μg | 45 |
| Vitamin B6 | μg | 150 |
| Riboflavine (Vitamin B2) | μg | 300 |
| Vitamin B1 (Thiamine) | μg | 200 |
| Vitamin B3 (Niacin) | μg | 4000 |
| Vitamin B12 (Cobalamin) | μg | 0.4 |
| Pantothenic acid | μg | 1250 |
| Biotin | μg | 3.72 |
| Choline | Mg | 16 |
| | OTHER NUTRIENTS | |
| Taurine | Mg | 6.9 |
| Carnitine | Mg | 3.0 |
| Inositol | Mg | 44 |
| | NUCLEOTIDES | |
| AMP | Mg | 0.56 |
| CMP | Mg | 1.9 |
| GMP | Mg | 0.39 |
| IMP | Mg | 0.23 |
| UMP | Mg | 0.76 |

The disclosure has been sufficiently described such as a person with middle knowledge in the matter is able to reproduce and obtain the results mentioned in the present disclosure. Nevertheless, any skillful person in the field of the technique that corresponds to the present disclosure is able to make no descript modifications in the present solitude. However, if the application of these modifications in a determinate structure or within the process of manufacture requires the material claimed in the following claims, these structures must be content inside the range of the disclosure.

1. An infant composition characterized because per every 100 total kcal of the formula, protein supplies between 5 to 20 kcal, being preferred between 10.4 and 14.4 kcal; still preferably 12.4 kcal; carbohydrates supply between 20 and 50 kcal, being preferred 38 kcal; and the fat supplies between 39.6 and 55 kcal, preferably 49 kcal.

2. The composition of the claim 1, characterized wherein comprises casein; whey milk protein; alphalactalbumin; beta-casein A2 protein; palmitic acid; non digestible oligosaccharides; long chain polyunsaturated fatty acids (LC PUFAS); nucleotides; vitamins and minerals; inositol; choline, taurine; and carnitine.

3. The composition of claim 2 wherein the ratio whey protein:casein is found between 80:20 and 20:80, preferably 65:35.

4. The composition of claim 2, wherein the content of alphalactalbumin with respect to the total protein content is between 20 and 30%, preferably 26%.

5. The composition of claim 2, characterized because from the total beta casein protein, the ratio between type A1 and A2 is found between 3:97 and 70:30, preferably in a ratio 40:60.

6. The composition of claim 2, characterized because the main source of protein proceeds from Jersey or Guernesey cattle milk with the objective of increasing the content of casein A2 to the mentioned concentrations in claim 5.

7. The composition of claim 1, wherein the carbohydrate is supplied as a mixture of lactose, maltodextrin and starch.

8. The composition of claim 1, wherein the content of lactose is found between 10 and 70% of the total carbohydrates, preferably 50%.

9. The composition of claim 1, wherein the palmitic acid is found to form between the 10 and 50% of the total fatty acids, preferably 25%.

10. The composition according to claim 1, wherein the total palmitic acid, from between the 25 and 70% is found esterified in position 2 of glycerol (beta palmitate), preferably 45%.

11. The composition according to claim 1 which is enriched with docosahexaenoic acid (DHA) and arachidonic acid (ARA).

12. The composition according to claim 1 wherein DHA is found in a quantity that represents from 1 to 5% of total fatty acids, while the arachidonic acid (ARA) is found in ratio from 1-10% from total fatty acids, more adequately, both fatty acids are found in a ratio ARA:DHA 1:2 to 5:1, preferably from 1:1 to 3:1, still preferably 2:1.

13. The composition of the disclosure according to claim 1, which is enriched with oligosaccharides present in breast milk.

14. The composition according to claim 13, wherein prebiotic oligosaccharides are fructooligosaccharides and galactooligosaccharides.

15. The composition according to claim 14, wherein the fructooligosaccharides are found in concentration between 0.05 and 0.2 grams per every 100 g of formula; preferably 0.533 g/100 g of formula.

16. The composition according to claim 14, wherein the galactooligosaccharides are found in concentration between 0.1 and 10 grams per every 100 g of formula; preferably 4.79 grams per every 100 g of formula.

17. The composition according claim 2, which is enriched with a nucleotides mixture in a ratio between 1 and 15 mg per every 100 kcal; preferably 3.8 mg/100 kcal.

18. The composition according to claim 1, wherein the nucleotides mixture is formed as follows:
Adenosine monophosphate (AMP) between 0.1 and 3.5 mg/100 kcal, preferably 0.56 mg/100 kcal.
Cytidine monophosphate (CMP) between 0.5 and 5 mg/100 kcal, preferably 1.9 mg/100 kcal.
Guanosine monophosphate (GMP) between 0.1 and 5 mg every 100 kcal, preferably 0.39 mg per every 100 kcal.
Inosine monophosphate between 0.01 mg and 5 mg per every 100 kcal, preferably 0.23 mg per every 100 kcal.
Uridine monophosphate between 0.1 mg and 7 mg per every 100 kcal, preferably 0.76 mg per every 100 kcal.

19. A composition according to claim 2, in which the vitamins and minerals are selected among sodium, potassium, calcium, phosphorus, chlorine, magnesium, manganese, iron, copper, zinc, selenium, iodine, vitamin A, C, D, E, K, all vitamins from B complex (B1, B2, B6 and B12), niacin, pantothenic acid and mixtures of them.

20. The composition according to claim 1, which is added with inositol in concentrations between 2 and 54 mg per every 100 kcal, preferably 44 mg per every 100 kcal.

21. The composition according to claim 1, which is added with choline in concentrations between 5 and 30 mg per every 100 kcal, preferably 16 mg per every 100 kcal.

22. The composition according to claim 1, which is added with taurine in concentrations between 5 and 12 mg per every 100 kcal, preferably 6.9 mg per every 100 kcal.

23. The composition according to claim 1, which is added with carnitine in concentrations between 1 and 15 mg per every 100 kcal, preferably 3.0 mg per every 100 kcal.

24. The composition according to claim 2 wherein the final product may be powder which must be mixed with water before use or in which the final product may be presented as a sterile liquid ready to use.

25. A composition of an Infant Formula for preterm infants characterized by its content of more than 60% of beta casein A2 from the total beta casein protein.

26. The use of beta casein A2 for the making of a composition of Infant Formula for premature infants where from the total beta casein protein, more than 60% is beta casein A2.
